(19) United States
(12) Patent Application Publication
(10) Pub. No.: US 2025/0206396 A1
(43) Pub. Date: Jun. 26, 2025

(54) TRACK-SHOE TRANSPORT SYSTEM

(71) Applicant: Topy Kogyo Kabushiki Kaisha, Tokyo (JP)

(72) Inventors: Yusuke KIMPARA, Tokyo (JP); Kazuhito TAKANASHI, Tokyo (JP); Kenta ICHIHARA, Tokyo (JP); Shingo TSUKUI, Tokyo (JP)

(73) Assignee: Topy Kogyo Kabushiki Kaisha, Tokyo (JP)

(21) Appl. No.: 18/852,077

(22) PCT Filed: Feb. 24, 2023
(86) PCT No.: PCT/JP2023/006660

§ 371 Date: Sep. 27, 2024

(30) Foreign Application Priority Data
Mar. 28, 2022 (JP) 2022-051639

(51) Int. Cl. B62D 65/18; B62D 55/32

(52) U.S. Cl. CPC B62D 65/18; B62D 55/32

(57) ABSTRACT

The purpose of the present invention is to provide a track shoe transport system capable of accurately placing a track shoe, which is a heavy item loaded on a pallet, on a link belt on a transport line. For that purpose, a track shoe transport system (50) according to the present invention comprises a track shoe supply unit (50A) provided with a pallet on which a track shoe (2) is loaded and a lift device for the pallet, a track shoe detection mechanism (50B) that detects the track shoe supplied from the track shoe supply unit, a control device (100) that determines a state of the track shoe (a front side or rear side and positions of a long side and a short side of the track shoe) detected by the track shoe detection mechanism, a track shoe pickup mechanism (50C) that picks up the track shoe detected by the track shoe detection mechanism, a track shoe transfer device (50D) that transports the track shoe picked up by the track shoe pickup mechanism, a track shoe arranging mechanism (50E) that arranges the track shoe transported by track the shoe transfer device in corporation with a relevant track and in alignment with each partition of the link belt (10), and a link belt transport device that transports the link belt and the track shoe on the link belt.

### TECHNICAL FIELD

The present invention relates to a system for setting a track shoe (crawler shoe) placed on a loading pallet in order to assemble the track shoe to a link belt and for transporting it to a bolt-nut fastening device in a subsequent process.

First, with reference to a FIG. 17, construction of an endless track belt will be simply explained.

The endless track belt is constructed as a construction machinery underbody component in which a shoe is mounted on a link belt, which is a link assembly that a link, a pin, and a bush are connected in a chain state, and as exemplified in FIG. 17, a track shoe 2 is mounted to a pair of links 1, 1A.

In the links 1, 1A, pin holes 11, 11A and bush holes 7, 7A are formed. In an example in FIG. 17, in the links 1, 1A, a window hole 12 is formed in a region between the pin hole 11 and the bush hole 7. In an inner surface of the window hole 12, a bolt hole 14 is formed, the bolt hole 14 is formed for insertion of a bolt 5, and the track shoe 2 is mounted to the links 1, 1A by the bolt 5.

In the link assembly device, not shown, a bush 4 is fitted (pressed) into the bush holes 7, 7A. Moreover, into the pin holes 11, 11A, a pin 3 is fitted (pressed). Furthermore, by inserting a pin into the bush, each frame 30 of the link belt is connected to an adjacent frame, which constructs a single continuing chain-state link belt.

In a bolt-nut fastening device (not shown) in a subsequent process of the link assembly device, by inserting the bolt 5 through the bolt hole 14 in each of the links 1, 1A and a bolt hole 21 provided in the track shoe 2 and by fastening with a nut 6, the track shoe 2 is mounted and fixed on track-shoe mounting surfaces 15 of the links 1, 1A. The track-shoe mounting surface 15 is a rear surface of the link 1 which surface is not clearly indicated in FIG. 17. Note that the track-shoe mounting surface 15 is illustrated also in FIG. 15.

When an endless track belt is to be manufactured, the constructional components (the bush 4, the pin 3, the links 1, 1A) other than the track shoe 2 in FIG. 17 are connected in the chain state so as to construct the link belt, and the track shoe 2 is fastened to the link belt. At that time, the link belt is transported by a link-belt transport device 50F toward the bolt-nut fastening device on a downstream side. On the other hand, the track shoe 2 is, after being rolled, manufactured through a predetermined machining process and after the manufacture, loaded on a pallet (not shown in FIG. 17) and moved.

In order to fasten the track shoe 2 to each piece of the link belt, it is necessary for the track shoe 2 loaded on the pallet needs to be disposed in a proper manner with respect to the link belt on the link-belt transport device being transported toward the bolt-nut fastening device. Note that, the proper aspect (manner, embodiment) means a state that long sides and short sides of the adjacent track shoes properly overlap with each other, which will be described later in detail.

However, since the track shoe 2 has a large weight (60 to 70 kg/sheet or 60 to 70 kg/piece), it is difficult to be manually placed on the link belt by operators.

Moreover, if the track shoe 2 is placed on the link belt by using a multi-axis robot, the structure thereof is complex, a failure occurrence frequency rises by that portion, a repair time at a failure increases and a risk of line stop should be risen. Moreover, since there is a risk of incurring an accident involving a human, and thus, it is necessary to take safety measures such as ensuring an excessive space so that a human cannot easily enter a movable range of the multi-axis robot and covering the multi-axis robot with a partition or the like, which makes installation of the device in a limited space difficult.

As the other prior arts, there are an art of recognizing three-dimensional positions of a plurality of moving targets (Patent Literature 1), an art of automatic sorting of components using a multi-axis robot (Patent Literature 2), and an art being capable of determining a material or the like of a work even if a distance from a light source to the work is changed (Patent Literature 3).

However, Patent Literature 1 is an art of detecting a position of an object to be measured by an infrared camera, but since it does not have a function of identifying a plurality of different products and a function of identifying a direction in which the product is placed or the like, it cannot determine a difference in the shape by the type of the track shoe or a direction in which the track shoe is placed so as to pick up the track shoe appropriately.

In the method of Patent Literature 2, a plurality of different products can be identified, but since there is not a function for setting a component at an assembling position, it cannot be applied to a system for setting a track shoe to a link belt.

The method of Patent Literature 3 is capable of identifying a plurality of different products and determining a material quality, but since it does not have a function for transporting the products or setting them at the assembling positions, it cannot be applied to a system for setting the track shoe to the link belt. Moreover, when the multi-axis robot is applied, since there is a problem of an opportunity loss caused by a failure frequency or a time lag to recovery from the failure, it is improper for a system for placing a track shoe on the link belt being transported to the bolt-nut fastening device.

### CITATION LIST

### Patent Literature

Patent Literature 1: Japanese Patent Application Publication No. 2021-167751
Patent Literature 2: Japanese Patent Application Publication No. 2019-059004
Patent Literature 3: Japanese Patent Application Publication No. 2011-156602

### SUMMARY OF INVENTION

### Technical Problem

The present invention was proposed in view of the aforementioned problems in the prior art and has an object to provide a track-shoe transport system which can accurately dispose a track shoe, which is a heavy item loaded on a pallet, on a link belt on a link-belt transport device.

### Means for Solving Problem

A track-shoe transport system (50) of the present invention is characterized comprising:
a track-shoe supply unit (50A) accommodating a pallet (55) on which a track shoe (2) is loaded and being provided a lift device (56) lifting the pallet (55);
a track-shoe detection mechanism (50B) which detects the track shoe (2) supplied from the track-shoe supply unit (50A);
a control device (100: control unit) which determines a state (a front side and a rear side, positions of a long side and a short side of the track shoe and the like) of the detected track shoe (2) on the basis of a detection result of the track-shoe detection mechanism (50B);
a track-shoe pickup mechanism (50C: 3-axis orthogonal robot) which picks up the track shoe (2) detected by the track-shoe detection mechanism (50B);
a track-shoe transfer device (50D) which transports the track shoe (2) picked up by the track-shoe pickup mechanism (50C) (to a link-belt transport device 50F);
a track-shoe disposition (arranging) mechanism (50E: 2-axis orthogonal robot) which disposes (arranges) the track shoe (2) transported by the track-shoe transfer device (50D) in alignment with each piece of the link belt (10) (being transported on the link-belt transport device 50F); and
a link-belt transport device (50F) which transports the link belt (10) and the track shoe (2) (being disposed on the link belt 10 by the track-shoe disposition mechanism 50E) (and supplies them to a bolt-nut fastening device on a downstream side).

In the present invention, it is preferable that the track-shoe detection mechanism (50B) is fixed and has a function for photographing a plurality of the track shoes (2) on an uppermost stage loaded on the pallet (55) and for providing information related to the plurality of track shoes (2) to a control device (100), and that
the control device (100) has a function for determining a type of the track shoe (2), a position of the bolt hole (21A, 21B, 21C, 21D), a direction in which a rug (R1, R2, R3) protrudes and a depth of the rug, and a front side and a rear side of the track shoe on the basis of information dispatching from the track-shoe detection mechanism (50B) and a function for determining an order of taking out (picking up) the track shoe (2).

Alternatively, in the present invention, it is preferable that the track-shoe supply unit has a photoelectric sensor (54), the photoelectric sensor (54) is fixed and has a function for measuring a perpendicular-direction distance (distance in an arrow-V direction) between the uppermost track shoe (2) and the track-shoe detection mechanism (50B) in the track shoe (2) loaded on the pallet (55) and for providing it to the control device (100), and
the control device (100) preferably has a function for lifting up the lift device (56) if the perpendicular-direction (arrow-V direction) distance between the uppermost track shoe (2) loaded on the pallet (55) and the track-shoe detection mechanism (50B) is less than a predetermined distance (1,250 mm, for example), and a function for stopping the lifting of the lift device (56) if the perpendicular-direction (arrow-V direction) distance between the uppermost track shoe (2) loaded on the pallet (55) and the track-shoe detection mechanism (50B) is equal to or larger than the predetermined distance (1, 250 mm, for example).

Moreover, in the present invention, it is preferable that a track-shoe reversing device (70) is provided on a side being away from the track-shoe supply unit (50A: or the pallet 55) in the track-shoe transfer device (50D), and the track-shoe reversing device (70) preferably includes:
a reversing member (75) which rotationally moves around a rotational-movement center (74) (in an arrow-AR direction);
a track-shoe receiving base (76) which receives the reversed track shoe (2);
a fulcrum member (77) to be a support (fulcrum) of reversing when the track shoe (2) is reversed by the reversing member (75); and
a pressing member (78) which presses the track shoe (2) in a state that the rug (R1 to R3) being reversed and facing upward so as to make the track shoe (2) slides on the track-shoe transfer device (50D).

When the present invention is to be embodied, it is preferable that the track-shoe pickup mechanism (50C) is constructed by a 3-axis orthogonal robot; and
the track-shoe disposition mechanism (50E) is constructed by a 2-axis orthogonal robot.

Moreover, the control device (100) preferably constructs artificial intelligence.

### Advantageous Effects of Invention

According to the present invention including the aforementioned constructions, processing of the track shoe (2) can be carried out correspondingly to a processing speed of a bolt-nut fastening device in a subsequent process by shortening a cycle time as compared with prior arts. That is, one sheet of the track shoe (2) can be automatically supplied (input) into the bolt-nut fastening device at a predetermined target speed (a cycle time of 8.5 seconds, for example). At the same time, a plurality of types of processing which should be carried out to the track shoe (2) can be carried out in parallel for each state of the track shoe (2).

Also, since such heavy labor that the track shoe (2), which is a heavy item (60 to 70 kg/sheet), is manually supplied into a line repeatedly can be excluded, the number of workers can be decreased, and therefore, labor costs can be reduced.

The system according to the present invention can be installed in a small space (4 m×3.5 m, for example) and can solve the problem related to an installation space in the track-shoe transport system (50).

Moreover, according to the present invention, since use of expensive equipment is not indispensable, introduction costs can be kept low, and high productivity (a cycle time of 8.5 seconds, for example) can be ensured.

In the present invention, in a case that the track-shoe detection mechanism (50B) has a function for photographing a plurality of track shoes (2) on the uppermost stage loaded on the pallet (55) and for providing information related to the plurality of track shoes (2) to the control device (100), and that
the control device (100) has a function for determining the type of the track shoe (2), the position of the bolt hole (21A, 21B, 21C, 21D), the direction and the depth of the rug (R1, R2, R3) and the front side and the rear side of the track shoe (2) and a function for determining an order of taking out (picking up) the track shoe (2) on the basis of information from the track-shoe detection mechanism (50B),
the track shoe (2) loaded on the pallet (55) can be transported on the track-shoe transfer device (50D) in the same attitude and disposed properly on the corresponding link belt (10).

Moreover, in a case that an infrared 3D camera is applied for the track-shoe detection mechanism (50B), it is markedly inexpensive as compared with a laser 3D scanner, whereby the installation cost of the track-shoe transport system (50) of the present invention can be kept low.

Moreover, in the present invention, in a case that the track-shoe supply unit has the photoelectric sensor (54), the photoelectric sensor (54) is fixed, and has a function for measuring a perpendicular-direction distance (distance in the arrow-V direction) between the uppermost track shoe (2) in the track shoes (2) loaded on the pallet (55) and the track-shoe detection mechanism (50B) and of providing it to the control device (100), and that
the control device (100) has a function for lifting the lift device (56) so that the perpendicular-direction (arrow-V direction) distance between the uppermost track shoe (2) loaded on the pallet (55) and the track-shoe detection mechanism (50B) becomes the predetermined distance (1,250 mm, for example),
an optimal field of view can be ensured when the track-shoe detection mechanism (50B) photographs an image of the track shoe to be picked up (2: track shoe to be taken out) in the track shoe (2) loaded on the pallet (55) and located at the uppermost, optimal accuracy for recognition of the type or direction etc. of the track shoe can be ensured, and it is possible to prevent interference with the track-shoe detection mechanism (50B) when the track-shoe pickup mechanism (50C) picks up the track shoe (2) and moves to the track-shoe transfer device (50D).

And in the present invention, if the track-shoe reversing device (70) is provided on the side separated from the track-shoe supply unit (50A: or pallet) in the track-shoe transfer device (50D),
in a case that the directions of the rugs (R1 to R3) in the track shoe (2) are opposite to a predetermined direction (for example, the track shoe 2 is placed on the track-shoe transfer device 50D in a state facing downward, in a case that the rugs 1 to R3 have to be transported in a state facing upward), the track shoe facing the opposite (2: the track shoe with the rugs R1 to R3 facing downward, for example) is reversed, and the directions of the rugs (R1 to R3) in the track shoe (2) transported by the track-shoe transfer device (50D) can be all caused to be directed to the same predetermined direction (the rugs R1 to R3 of all the track shoes 2 transported by the track-shoe transfer device 50D can be brought into the state facing upward, for example).

Here, by providing the track-shoe reversing device (70) on the side separated from the track-shoe supply unit (50A: or pallet) in the track-shoe transfer device (50D), in a region in which the track-shoe pickup mechanism (50C: 3-axis orthogonal robot) picks up the track shoe and places it on the track-shoe transfer device (50D), a movement amount in the up-down direction (perpendicular direction: Z-axis direction) of the track-shoe pickup mechanism (50C) can be reduced.

### BRIEF DESCRIPTION OF DRAWINGS

FIG. 1 is a perspective view illustrating an outline of a track-shoe transport system according to an embodiment of the present invention.

FIG. 2 is a plan view of the system shown in FIG. 1.

FIG. 3 is a side view of the system shown in FIG. 1.

FIG. 4 is a perspective view of a track shoe exemplified in the illustrated embodiment.

FIG. 5 is an explanatory view of a long side and a short side of the track shoe.

FIG. 6 is an explanatory view of a track-shoe supply unit.

FIG. 7 are explanatory views illustrating a depth DP in the track shoe.

FIG. 8 are explanatory views of a taking-out order (picking up order) by which the loaded track shoes collapse will not be happened.

FIG. 9 is an explanatory view illustrating an example of a manner for determining the short side and the long side of the track shoe.

FIG. 10 is an explanatory view illustrating an outline of a 3-axis orthogonal robot.

FIG. 11 is a drawing extracted from a part of FIG. 1 and is a perspective view illustrating the track-shoe supply unit, the 3-axis orthogonal robot and the track-shoe transfer device.

FIG. 12 is an explanatory diagram of a track-shoe reversing device and shows a state before the track-shoe reversing.

FIG. 13 is an explanatory diagram of the track-shoe reversing device and shows a state after the track-shoe reversing.

FIG. 14 is an explanatory diagram illustrating a relationship between a position of a track-shoe receiving base of the track-shoe reversing device and an up-down direction movement amount of a track-shoe pickup member.

FIG. 15 is an explanatory diagram illustrating a procedure in a manner of placing a track shoe on a link belt on a link-belt transport device.

FIG. 16 is an explanatory diagram illustrating an outline of a pitch feeding device in the link-belt transport device.

FIG. 17 is an explanatory diagram exemplifying a structure of an endless track belt.

FIG. 18 is an explanatory diagram illustrating a loaded situation of a large number of track shoes loaded on a pallet.

### DESCRIPTION OF EMBODIMENTS

Hereinafter, embodiments of the present invention will be explained with reference to the attached drawings.

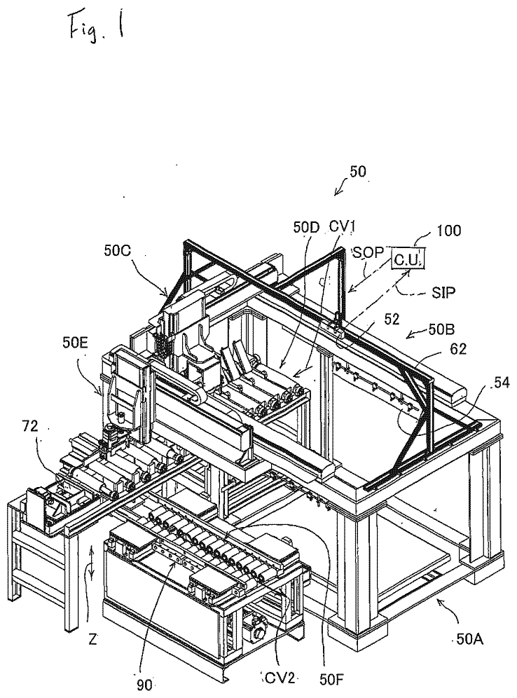

A track-shoe transport system according to the embodiment of the present invention is entirely indicated by a reference numeral 50 in FIGS. 1 to 3.

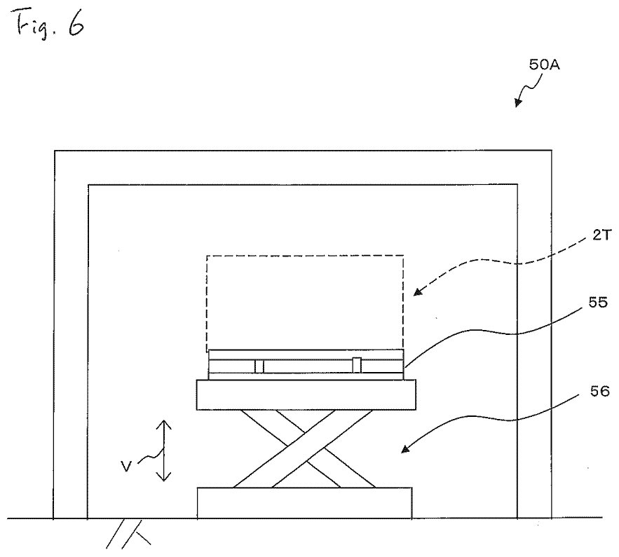

In FIGS. 1 to 3, the track-shoe transport system 50 comprises:
a track-shoe supply unit 50A accommodating a pallet 55 (see FIG. 6) on which a track shoe 2 is loaded, being provided with a lift device 56 (see FIG. 6) which lifts the pallet 55;
a track-shoe detection mechanism 50B which detects the track shoe 2 supplied from the track-shoe supply unit 50A;
a control device 100 (control unit) determining a state of the detected track shoe 2 (a front side and a rear side of the track shoe 2, positions of a long side 23 and a short side 22 of the track shoe 2, etc) on the basis of a detection result of the track-shoe detection mechanism 50B;
a 3-axis orthogonal robot 50C constructing a track-shoe pickup mechanism for picking up the track shoe 2 detected by the track-shoe detection mechanism 50B;
a track-shoe transfer device 50D which transports the track shoe 2 picked up by the 3-axis orthogonal robot 50C (to the link-belt transport device 50F);
a 2-axis orthogonal robot 50E constructing a track-shoe disposition mechanism which disposes the track shoes 2 transported by the track-shoe transfer device 50D in alignment with a link belt 10; and
a link-belt transport device 50F which transports the link belt 10 and the track shoe 2 (disposed on the link belt 10 by the 2-axis orthogonal robot 50E) and supplies them to a bolt-nut fastening device (not shown) on a downstream side.

The link belt corresponds to each of the track shoes 2 and is transported on the link-belt transport device 50F.

In FIGS. 1 to 3, a transport direction by the track-shoe transfer device 50D is indicated by an arrow CV1, and a transport direction by the link-belt transport device 50F (a link-belt feeding direction, which will be described later) is indicated by an arrow CV2.

In FIGS. 1 to 3, detection results of the track-shoe detection mechanism 50B and the photoelectric sensor 54 are input into the control unit 100 via a signal-transmission line SIP, and on the basis of a state of the track shoe determined by the control unit 100 (the front side and the rear side of the track shoe, positions of the long side and the short side and the like), a control signal is transmitted to the 3-axis orthogonal robot 50C, the track-shoe transfer device 50D, the 2-axis orthogonal robot 50E, and the link-belt transport device 50F via a signal transmission line SOP. In FIG. 1, a part of the signal transmission line SOP from the control unit 100 to the 3-axis orthogonal robot 50C, the track-shoe transfer device 50D, the 2-axis orthogonal robot 50E, the link-belt transport device 50F is shown merely, in order to avoid cumbersomeness of drawings.

Here, the control unit 100 can be constructed an artificial intelligence AI. By means of learning features of each type of a part constructing the track shoe, said AI has a function of determining capability of a type, a direction of a rug and the like of the detected track shoe and a function of improving accuracy thereof to a high level.

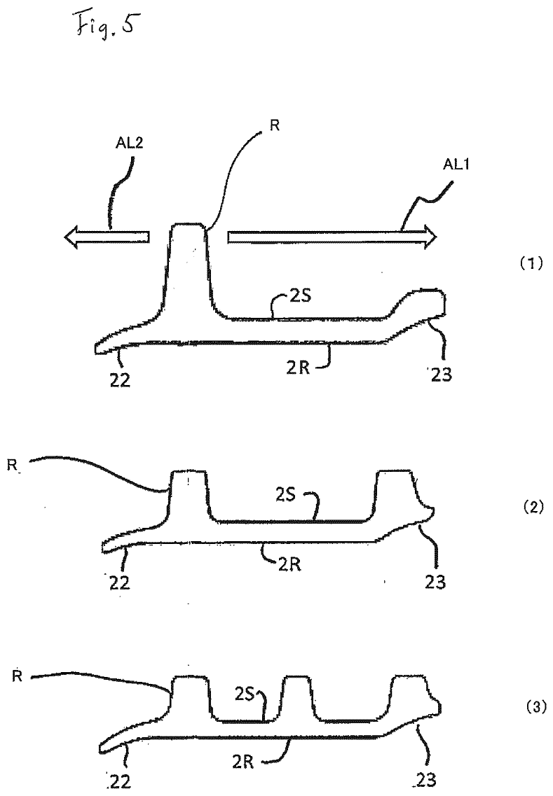

Regarding the track shoe 2, there are a type having a single rug R (so-called “single shoe”: see FIG. 5(1)), a type having two rugs R (so-called “double shoe”: see FIG. 5(2)), and a type having three rugs R (so-called “triple shoe”: see FIG. 5(3). One of the aforementioned three kinds (types) is selected by a determined type of the applied track shoe 2 in accordance with a machine body to which a track shoed is mounted. Here, it was difficult for the prior art to set or to dispose the track shoe to the link-belt transport device 50F in accordance with the type of the track shoe 2. As will be described later, in the illustrated embodiment, appropriate control is carried out by the track-shoe detection mechanism 50B (FIGS. 1 to 3) and the control device 100 (FIG. 1: control unit) so as to set the track shoe 2 exactly on the link-belt transport device 50F, in accordance with the type of the track shoe 2.

In the illustrated embodiment, a system is explained as an example, which system picks up the track shoe having three rugs R (R1 to R3) (so-called “triple shoe”: see FIG. 5(3)) out of a loading pallet and disposes said shoe on the link belt 10 on the link-belt transport device 50F appropriately in order to transport the bolt-nut fastening device in a subsequent process.

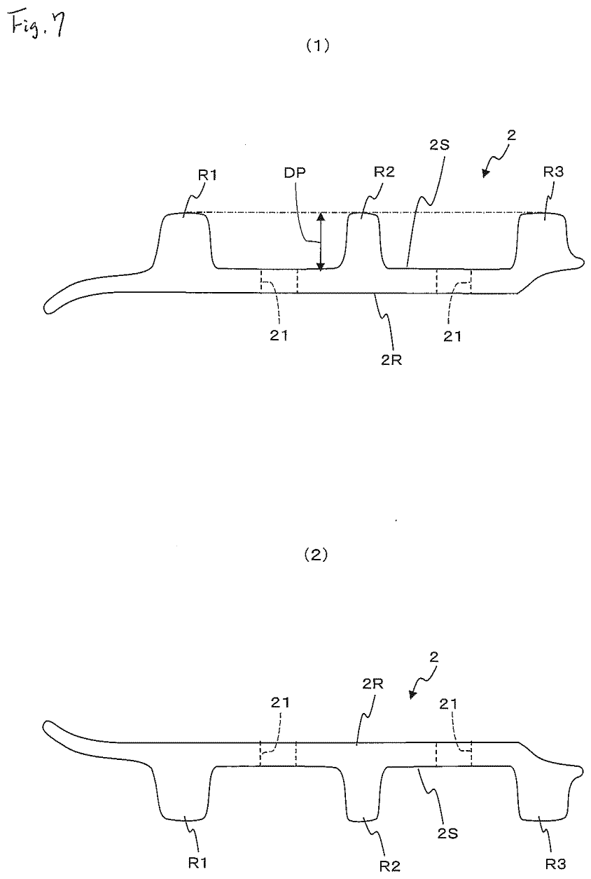

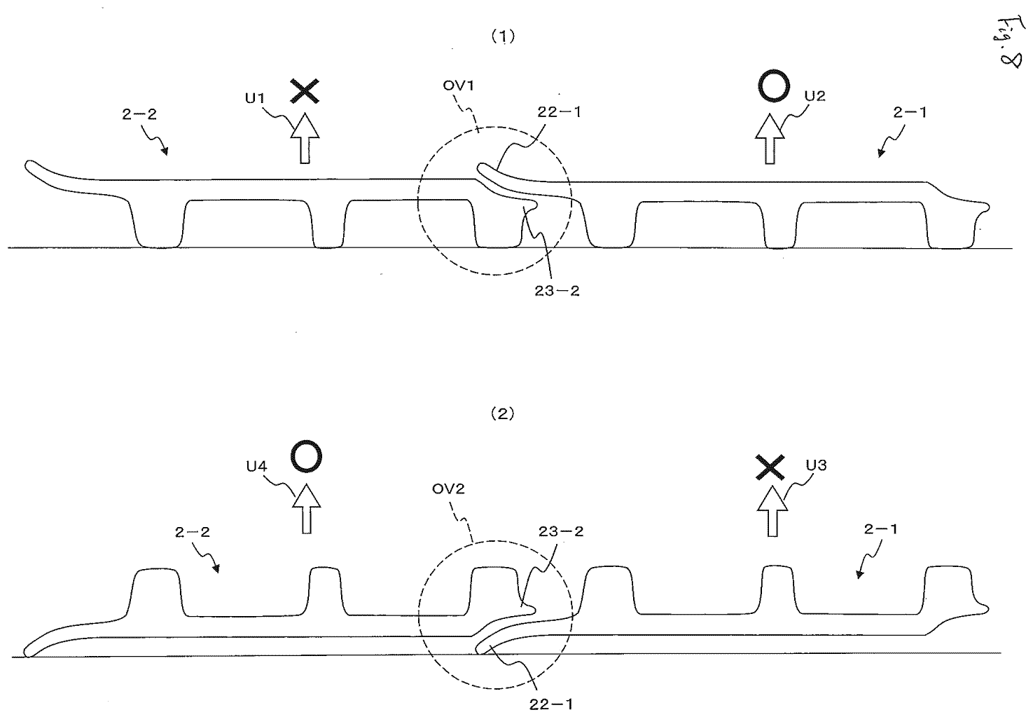

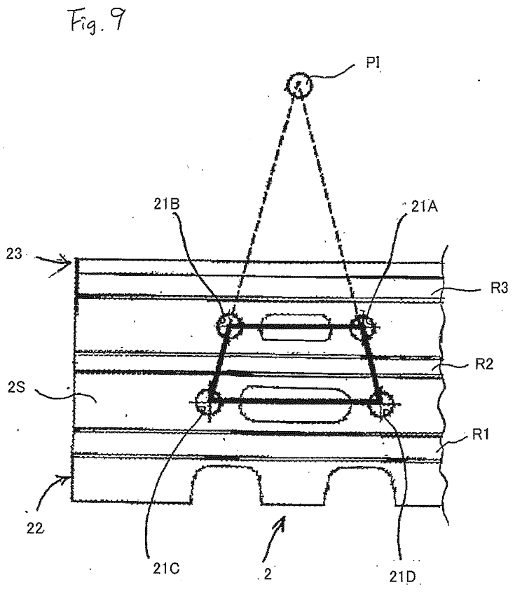

With reference to FIG. 7, the front side and the rear side of the track shoe 2 will be explained. FIG. 7 illustrates the triple-shoe track shoe 2, and then, in FIG. 7, a surface 2S on a side where the rugs R1 to R3 protrude is the “front side” of the track shoe 2, while a surface 2R on the opposite side (a side where the rugs R1 to R3 are not formed) is the “rear side”.

A side on which a distance from the rug R of the single shoe to an end part shown in FIG. 5(1) is long (arrow AL1 side) is a long-side side, and a side on which a distance from the rug R of the single shoe to an end part shown in FIG. 5(1) is short (arrow AL2 side) is a short-side side.

And the long side is indicated by a character 23, and the short side is indicated by a character 22. In the double shoe in FIG. 5(2) and the triple shoe in FIG. 5(3), with the rug corresponding to the rug R of the single shoe in FIG. 5(1) (rug with the same left-right direction position in FIG. 5: rug indicated by a character R) as a reference, the side where a distance from the rug R to the track-shoe end part is long is the long-side side, and the side where a distance from the rug R to the track-shoe end part a short is the short-side side.

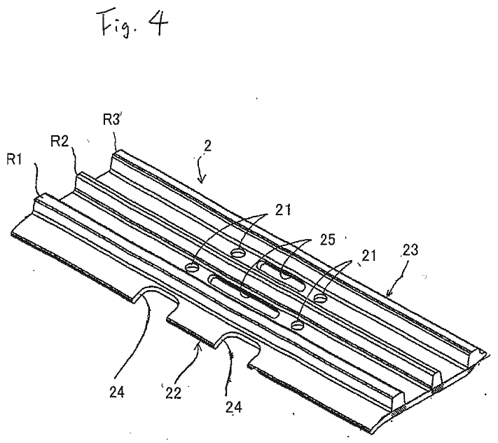

As shown in FIG. 4, the track shoe 2 exemplified in the illustrated embodiment has a groove 24 formed on the short-side 22 side, but the groove is not formed on the long-side 23 side. Note that, in FIG. 4, an elliptical hole 25 formed in an area between the bolt holes 21 is a mud removing hole.

Subsequently, with reference to FIG. 6, the track-shoe supply unit 50A (refer to FIGS. 1 to 3) will be explained.

In FIG. 1, the track-shoe supply unit 50A is illustrated as a hollow space, but in the hollow space in FIG. 1, as shown in FIG. 6, the lift device 56, the pallet 55 placed on the lift device 56, and a plurality of the track shoes 2 placed on the pallet 55 are accommodated.

The lift device 56 is constructed so as to be capable of vertical movement in the arrow-V direction. For the lift device 56, a well-known device can be applied.

In FIG. 6, a plurality of track shoes 2 placed on the pallet 55 is illustrated by a square 2T indicated by a dotted line, entirety. Though not clearly shown, in view of the fact that the rugs R1 to R3 (FIG. 4, FIG. 5) protrude in the plurality of track shoes 2, in order to improve loading efficiency, they are loaded in such a form that the front side and the rear side of the track shoe 2 are alternately reversed with respect to the up-down direction V. Moreover, the track shoes 2 adjacent in the up-down direction V are loaded so that the short sides 22 and the track-shoe long sides 23 thereof (FIG. 4, FIG. 5) are overlapped (FIG. 18). That is, when the track shoes 2 are vertically overlapped or when the track shoes 2 are made adjacent on the same plane, the track shoes 2 are placed on the pallet 55 such that the short side 22 of the track shoe overlaps the long side 23 of the track shoe of the adjacent track shoe in the up-down direction, and the long side 23 of the track shoe overlaps the short side 22 of the adjacent track shoe also in the horizontal direction. Thus, when the track shoe 2 placed on the pallet 55 is to be picked up, it is necessary to pick up so that the loaded track shoes 2 collapse will not be occurred. Also, as will be described later, in order to prevent the load collapse, it is necessary to be accurately determined the front side and the rear side of the track shoe 2 to be picked up and the long side 23 and the short side 22 of the track shoe 2.

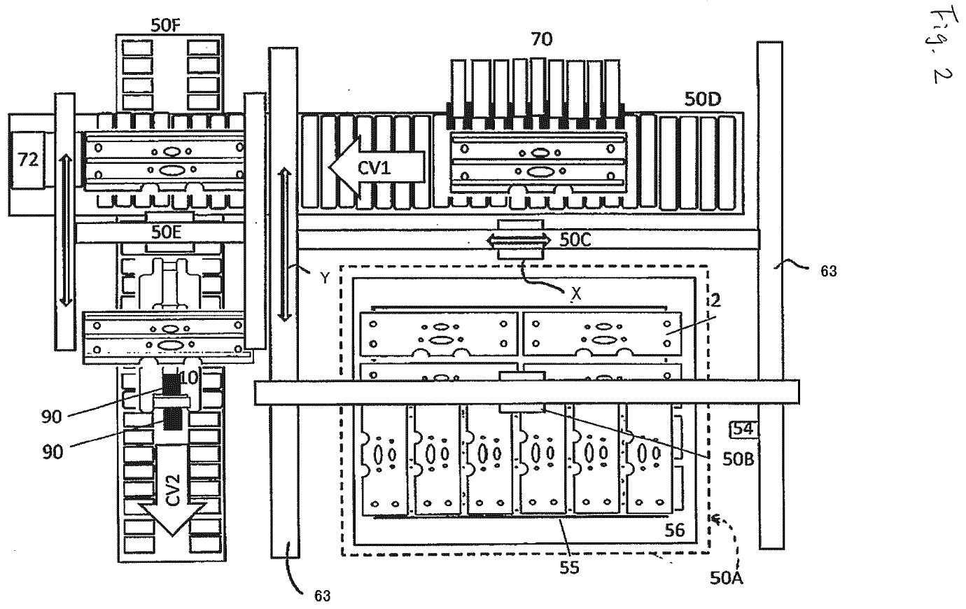

Here, in the track-shoe supply unit 50A shown in FIG. 2, an upper surface in a state that a large number of the track shoes 2 are loaded on the pallet 55 is shown, and the track shoes are loaded in a manner that each of the track shoes 2 directs to various directions on the pallet 55. It was difficult in the prior art to appropriately dispose the track shoes 2, each of which directs to the various directions, on the link belt 10 on the link-belt transport device 50F.

Moreover, FIG. 18 shows a side surface in a state that a large number of the track shoes 2 are loaded on the pallet 55. As shown in FIG. 18, in the loaded track shoes 2, the direction of the rug is upward or downward depending on how to be loaded. Therefore, it was also difficult in the prior art to dispose the track shoes 2 loaded as above-mentioned so as to face the rug upward all the time with respect to the link belt 10 on the link-belt transport device 50F.

On the other hand, in the illustrated embodiment, the plurality of track shoes 2, each of which is disposed so as to face various directions in the horizontal direction respectively and is disposed so that rugs face upward or downward depending on the loaded stage, are appropriately controlled by the track-shoe detection mechanism 50B (FIG. 1 to FIG. 3) and the control device 100 (FIG. 1: control unit) so that they are all appropriately disposed on the link belt 10 on the link-belt transport device 50F.

In the illustrated embodiment, the track shoe 2 supplied from the track-shoe supply unit 50A is detected by the track-shoe detection mechanism 50B (FIG. 1 to FIG. 3), and on the basis of the detection result of the track-shoe detection mechanism 50B, the control device 100 (control unit) determines the front side and the rear side of the detected track shoe 2 and the positions of the long side 23 and the short side 22. In FIG. 1 to FIG. 3, the track-shoe detection mechanism 50B is constructed by an infrared 3D camera 52.

In FIG. 1, the infrared 3D camera 52 is mounted on a frame body 62, and the frame body 62 is fixed to an outer frame of the 3-axis orthogonal robot 50C, whereby the position of the infrared 3D camera 52 is fixed. By adopting the infrared 3D camera 52 for photographing the track shoe 2, different from a case that an infrared 2D camera is adopted, recognition of a position in a depth direction (perpendicular direction: up-down direction: direction shown by an arrow-V in FIG. 6) is possible, and as a result, taking-out accuracy (picking up accuracy) of the track shoe 2 picking up by the 3-axis orthogonal robot 50C can be drastically improved. And the infrared 3D camera 52 can photograph the plurality of track shoes 2 which are loaded on the uppermost stage of the track shoes being loaded on the pallet 55, and can provide information of the photographed plurality of track shoes 2 to the control device 100.

Here, instead of the infrared 3D camera 52, a laser 3D scanner can be also applied. However, introduction costs of a laser 3D scanner is higher than introduction costs of a infrared 3D camera. Therefore, in the illustrated embodiment in which the infrared 3D camera 52 is applied, great advantages can be acquired also in the aspect of the installation costs.

In FIG. 1 to FIG. 3, on the basis of the photographed image of the track shoe 2 picked up by the infrared 3D camera 52, the control device 100 (FIG. 1) acquires information relating to the type of the track shoe 2, the bolt hole position, the height, the direction of the rug R, and the direction of the track shoe 2. And the control device 100 determines the order in which the track-shoe pickup mechanism 50C (3-axis orthogonal robot) picks up the track shoe 2 from the track-shoe loading pallet 55 based on the information as mentioned above, and transmits a control signal to the 3-axis orthogonal robot 50C via the signal transmission line SOP.

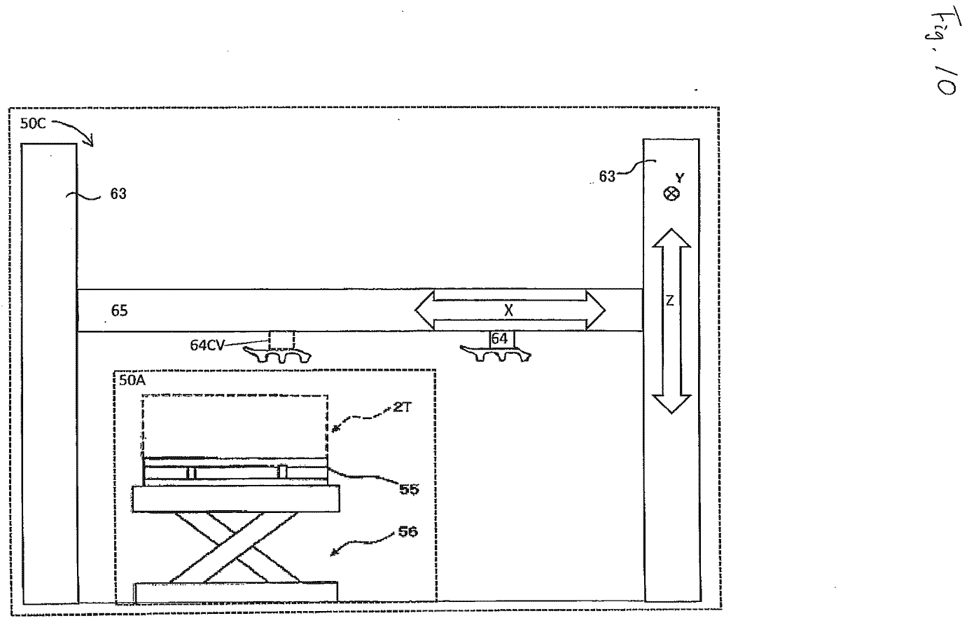

A track-shoe pickup member 64 (see FIG. 10) of the 3-axis orthogonal robot 50C moves correspondingly according to the above-mentioned order, to the positions of the track shoe 2 to be picked up and attracts the track shoe 2 by a magnetic force, for example, and the member 64 picks up the track shoe 2 up. Here, the position of the track shoe 2 corresponding to the determined order is determined on the basis of a coordinate in a height direction (coordinate in the arrow-Z direction in FIG. 10), a coordinate on a plane (FIG. 10: coordinate in the XY-axis direction), the bolt hole position of the track shoe 2 and the like.

A manner that the track shoe 2 is picked up by the track-shoe pickup member 64 of the 3-axis orthogonal robot 50C and is transferred to the track-shoe transfer device 50D (FIG. 1 to FIG. 3) will be described later with reference to FIG. 10.

On the basis of the information transmitted from the infrared 3D camera 52, the control device 100 determines, for example, the position of the center of the track shoe 2, the front side and the rear side of the track shoe 2, and the taking-out order (picking up order) of the track shoe 2 without causing the track shoes 2 making load collapse which shoes are loaded on the pallet 55.

Regarding the center point of the track shoe 2, a center point (a gravity-center position) of the track shoe is calculated by recognizing images of the bolt holes 21 (FIG. 4) at four spots. For example, by pre-determining and storing relationships between the bolt holes 21 at the four spots and the center point (gravity center) in the control device 100 in advance, the position of the center point of the track shoe 2 can be determined from the positions of the bolt holes 21 at the four spots.

Though not shown in the drawings, by means of making the AI of the control device 100 learning the relation between the bolt holes 21 at the four spots and the center point (gravity center) in advance and by recognizing the images of the bolt holes 21 (FIG. 4) at the four spots, as the result of the learning, the type of the track shoe 2 can be identified.

As will be described later, by attracting the center point or the gravity center of the track shoe 2 by the track-shoe pickup member 64 (FIG. 10) of the 3-axis orthogonal robot 50C, the track shoe 2 can be picked up (by the 3-axis orthogonal robot 50C) without inclination and be moved to a predetermined spot (track-shoe transfer device 50D: FIG. 1 to FIG. 3).

The front side or the rear side of the track shoe 2 is determined by the “depth” thereof. As described above, the side where the rug R protrudes in the track shoe 2 is assumed to be the “front side” (front side 2S of the track shoe 2), while the side opposite to the protrusion of the rug R is assumed to be the “rear side” (rear side 2R of the track shoe 2). The “depth” will be explained later with reference to FIG. 7.

As shown in FIG. 7(1), in the track shoe 2 in which the “front side” is on the upper side, there is a distance (length of an arrow DP) between a top surface of the rug R (R1, R2, R3) and the plane in which the bolt hole 21 is formed. The distance DP between a spot (top surface of the rug R) which is first detected by the infrared 3D camera 52 as the track shoe 2 and the bolt hole 21 is the “depth”.

On the other hand, as shown in FIG. 7(2), in the track shoe 2 in which the “rear side” is on the upper side, the infrared 3D camera 52 recognizes the bolt hole 21 at first. Thus, the distance between the first recognized part and the plane in which the bolt hole 21 is formed is zero. Such a state is a state so-called “without the depth (DP)”.

That is, the control device 100 can determine the front side or the rear side of the track shoe 2 to be picked up on the basis of whether or not the depth DP is equal to or larger than a predetermined value (threshold value). That is, the control device 100 can determine whether the rug R is the “front side” facing upward (the depth DP is equal to or larger than the threshold value) or the rug R is the “rear side” facing downward (the depth DP is less than the threshold value). The predetermined value (threshold value) can be set to a numerical value being larger than zero and not exceeding a height dimension of the rug R.

Though not clearly illustrated, it is possible to determine that “the track shoe 2 is the front side” in a case that the infrared 3D camera 52 being located above the loading pallet 55 (FIG. 6) recognizes the rug R all the time, while it is possible to determine that “the track shoe 2 is the rear side” in a case that the rug R is not recognized.

The manner in which the taking-out order (picking up order) of the track shoe 2 is determined is explained with reference mainly to FIG. 8, in which manner a load collapse of the loaded track shoes 2 prevent will not be happened.

As shown in FIG. 8(1), in a case that the track shoes are adjacent to each other in a state in which the rear surface of each of the track shoe 2 is located above, at the overlap spot indicated by a character OV1, the short side 22 is located on the upper side of the long side 23.

In the state shown in FIG. 8(1), if a track shoe 2-2 on a left side is picked up prior to a track shoe 2-1 on a right side and moved upward direction (arrow U1) (“cross” in FIG. 8(1)), a short side 22-1 side of the track shoe 2-1 on the right side is lifted upward (arrow-U1 direction) by a long side 23-2 of the track shoe 2-2 on the left side, and thus, it is possible to make the load collapse of the track shoe 2-1 on the right side. On the other hand, if the track shoe 2-1 on the right side is picked up first and moved upward direction (arrow U2) (“circle” in FIG. 8(1)), since the short side 22-1 of the track shoe 2-1 on the right side is located above the long side 23-2 of the track shoe 2-2 on the left side, the long side 23-2 side of the track shoe 2-2 on the left side is not lifted upwardly by the short side 22-1 or the track shoe 2-2 on the left side will not make a load collapse.

In the track shoe 2 handled in the illustrated embodiment, as shown in FIG. 4, the groove 24 is formed on the short side 22 side, but the groove is not formed on the long side 23 side. Therefore, in the state shown in FIG. 8(1), since the groove 24 formed in the short side 22-1 of the track shoe 2-1 on the right side is located above the long side 23-2 of the track shoe 2-2 on the left side, when the overlap spot OV1 is viewed from above area, (at the overlap spot OV1) the groove 24 can be visually recognized (the groove 24 can be recognized). Therefore, in the state shown in FIG. 8(1), if the groove 24 is in a state capable of being visually recognized at the overlap spot OV1, by picking up the track shoe 2-1 in which the groove 24 is formed (the track shoe 2-1 on the right side in FIG. 8(1): the track shoe with the short side 22-1 disposed at the overlap spot OV1) prior to the track shoe 2-2 (track shoe with the long side 23-1 disposed at the overlap spot OV1), the load collapse does not occur.

Here, in the state that the rear surface of the track shoe 2 is located above as in FIG. 8(1), in order to improve the loading efficiency of the track shoe 2, the short side 22 is disposed above the long side 23 at the overlap spot OV1. At the overlap spot OV1, the long side 23 is not disposed above the short side 22.

On the other hand, as shown in FIG. 8(2), in a case that the track shoes are adjacent to each other in a state that the front surface of the track shoe 2 is located above, at the overlap spot indicated by a character OV2, the short side 22 is located on a lower side of the long side 23. In the state shown in FIG. 8(2), if the track shoe 2-1 on the right side is picked up prior to the track shoe 2-2 on the left side and is moved upward direction (arrow U3) (“cross” in FIG. 8(2)), the long side 23-2 of the track shoe 2-2 on the left side is lifted upward direction by the short side 22-1 of the track shoe 2-1 on the right side, and then, it is possible for the track shoe 2-2 on the left side make a load collapse or to be collapsed. On the other hand, if the track shoe 2-2 on the left side is picked up first and moved upward (arrow U4) (“circle” in FIG. 8(2)), since the long side 23-2 of the track shoe 2-2 on the left side is above the short side 22-1 of the track shoe 2-1 on the right side, the track shoe 2-2 on the left side can be moved upward direction (picked up) without lifting-up of the short side 22-1 of the track shoe 2-1 on the right side. Thus, the track shoe 2-1 on the right side do not make a load collapse (not shifted).

As described above, the groove 24 is formed on the short side 22 side, but the groove is not formed on the long side 23 side. Therefore, in the state in FIG. 8(2), in a case that the overlap spot OV2 is viewed from an above area (at the overlap spot OV2), the long side 23-2 of the track shoe 2-2 on the left side (side which should be picked up first) covers the short side 22-1 of the track shoe 2-1 which should be picked up later, and the groove 24 cannot be visually recognized (the groove 24 cannot be recognized). Therefore, in a state that the groove 24 cannot be visually recognized at the overlap spot OV2, by means of picking up the track shoe 2-2 at first, the load collapse does not occur. In said track shoe to be picked up at first, the side being not formed the groove is positioned at an overlap part OV2 (the long side 23 of w track shoe 2 is disposed at the overlap spot OV2).

In a state that the surface of the track shoe 2 is located above as shown in FIG. 8(2), in order to improve the loading efficiency of the track shoe, the long side 23 is disposed above the short side 22 at the overlap spot OV2. The short side 22 is not disposed above the long side 23.

In the illustrated embodiment, by means of the information transmitted from the infrared 3D camera 52, in the control device 100, the short side 22 and the long side 23 of the track shoe 2 can be determined. As shown in FIG. 4, the bolt holes 21 are formed at the four spots in the track shoe 2, and based on the positions of the bolt holes 21 at the four spots, the short side 22 and the long side 23 of the track shoe 2 can be identified in the control device 100.

As shown in FIG. 9, the track shoe 2 to be transported in the illustrated embodiment has four bolt holes 21A, 21B, 21C, 21D, and the bolt holes 21A, 21B, 21C, 21D are drilled at positions corresponding to four corners of a trapezoid (isosceles trapezoid). The trapezoids 21A, 21B, 21C, 21D have upper sides (long side 23 sides) as upper bottoms and lower sides (short side 22 sides) as lower bottoms in FIG. 9.

As shown in FIG. 9, an extension line of the sides 21C, 21B, which is a leg of the trapezoid, and an extension line of the sides 21D, 21A, which is also a leg of the trapezoid, cross each other on the long side 23 side (upper side in FIG. 9), but do not cross on the short side 22 side (lower side in FIG. 9).

Thus, by detecting the positions of the bolt holes 21A, 21B, 21C, 21D and determining an intersection PI of the extension line of the sides 21C, 21B, which is a leg of the trapezoid, and the extension line of the sides 21D, 21A, which is also a leg of the trapezoid, it can be determined that the side where the intersection PI is present as the long side 23, while the side where the intersection PI is not present as the short side 22.

Here, FIG. 9 shows the track shoe 2 in a manner that a side being able to see the rugs R1 to R3 is shown, that is, front side 23 is shown. However, for the rear side where the rugs R1 to R3 are not seen, the long side and the short side can be determined by a similar manner.

Moreover, even in a case that the disposition of the bolt holes 21 is different from the track shoe 2 shown in FIG. 9, if the four bolt holes 21 are disposed in a trapezoid shape, by determining a spot (intersection) where the extension lines of the sides forming a pair of legs of the trapezoid cross each other, the long-side side and the short-side side of the track shoe 2 can be determined by a manner similar to the above mentioned manner.

Depending on the type of the track shoe, the bolt holes 21A, 21B, 21C, 21D are not positioned in correspondence with the four corners of the trapezoid but positioned in correspondence with four corners of a rectangle. In such a case, by recognizing whether the groove is formed in the track shoe 2, the side in which a groove is formed can be determined as the short side 22 side.

In the illustrated embodiment, a position of the photoelectric sensor 54 is fixed.

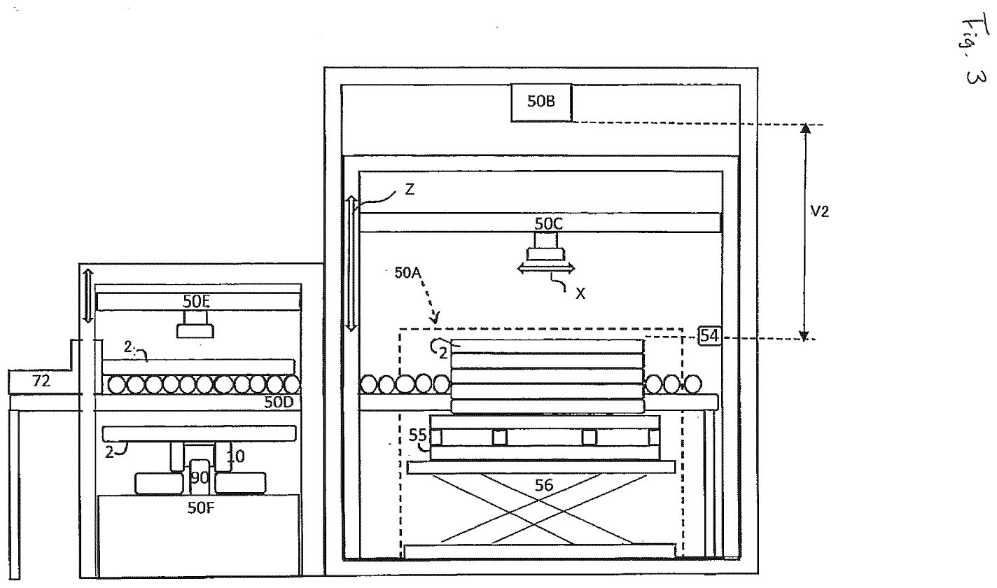

In FIG. 1 to FIG. 3, FIG. 6, the photoelectric sensor 54 has a function of measuring a perpendicular-direction distance V2 (FIG. 3: arrow-V direction distance in FIG. 6) between the track shoe 2 loaded on the pallet 55 (FIG. 6) and the infrared 3D camera 52.

When the control device 100 determines that all the track shoes 2 for one stage in the track shoes 2 loaded on the pallet 55 (FIG. 6) (In FIG. 6, the entire plurality of track shoes 2 on the pallet 55 are indicated by a dotted-line square 2T) have been transferred to the track-shoe transfer device 50D, the pallet 55 is lifted by the lift device 56 shown in FIG. 6. The lifting of the pallet 55 by the lift device 56 is performed until the perpendicular-direction distance between the uppermost track shoe 2 and the infrared 3D camera 52 (distance in the arrow-V direction in FIG. 6) at the point of time is equal to a predetermined distance. The predetermined distance is 1,250 mm, for example. In other words, in FIG. 6, the lift device 56 lifts the pallet 55 until the arrow-V direction distance between the track shoe 2 loaded on the uppermost side and the infrared 3D camera 52 is equal to the predetermined distance (1,250 mm, for example). When it is detected that the arrow-V direction distance between the track shoe 2 loaded on the uppermost side and the infrared 3D camera 52 has reached the predetermined distance (1,250 mm, for example), the lift device 56 stops the lifting by a control signal from the control device 100.

The lifting and stopping as mentioned above are performed each time that all the uppermost track shoes 2 loaded on the pallet 55 are picked up (all are transferred to the track-shoe transfer device 50D), and carried out until all the track shoes 2 on the pallet 55 have been transferred to the track-shoe transfer device 50D.

The track shoe 2 (uppermost track shoe 2) lifted to the position, at which the arrow-V direction distance from the infrared 3D camera is 52 the predetermined distance (1,250 mm, for example), is taken out (picked up) from a position being above the pallet 55 (FIG. 6) and is transferred to the track-shoe transfer device 50D, by means of the 3-axis orthogonal robot 50C.

In FIG. 10, the 3-axis orthogonal robot 50C includes the track-shoe pickup member 64, and the track-shoe pickup member 64 moves in an X-axis direction indicated by an arrow X, a Z-axis direction indicated by an arrow Z, and a Y-axis direction, which is a direction perpendicular to a paper surface of FIG. 10 (arrow-Y direction in FIG. 2). That is, the track-shoe pickup member 64 of the 3-axis orthogonal robot 50C moves in a three-dimensional manner in the XYZ-axis direction. The track-shoe pickup member 64 moves in the X-axis direction along a rail, not shown, being provided on a movement member 65 in the 3-axis orthogonal robot 50C. The movement member 65 is disposed in an area between a pair of wall-like members 63 and moves in the Y-axis direction, which is a direction perpendicular to the paper surface in FIG. 10 along a rail, not shown, being provided by extending in the Y-axis direction perpendicular to the paper surface in FIG. 10. Moreover, the movement member 65 moves in the Z-axis direction in FIG. 10 by a mechanism which is not shown in drawings.

A character 64CV shown in FIG. 10 virtually indicates the track-shoe pickup member 64 having moved to the position at which the track shoes 2 are loaded on the pallet 55.

As described above, in the track-shoe supply unit 50A, a large number of track shoes 2 are placed on the pallet 55, and the large number of track shoes 2 are entirely expressed by the square 2T indicated by a dotted line.

In FIG. 10, the track-shoe pickup member 64CV having moved to the position of the track shoe 2 loaded on the pallet 55 moves in the XYZ-axis direction to the position of the track shoe 2 to be taken out (to be picked up) on the basis of the order (see FIG. 8, for example) determined by the control device 100. Then, the track shoe 2 to be picked up is attracted by the track-shoe pickup member 64.

The track-shoe pickup member 64 attracts the track shoe 2 by a magnetic force, for example, and picks up the track shoe 2 from the plurality of track shoes 2 loaded on the pallet 55 in accordance with the determined picking-up order (see FIG. 5 to FIG. 9).

In FIG. 10, a distal-end member 64E contacts the center position (gravity-center position of the track shoe 2) of the four bolt holes 21A, 21B, 21C, and 21D (FIG. 9) in the track shoe 2, for example, and attracts the contacted track shoe 2 by the magnetic force.

In the distal-end member 64E, well known marketed products can be applied as a track-shoe attracting device (not shown) applying the magnetic force. Here, the center position of the track shoe 2 to be attracted by the distal-end member 64E can be determined by means of identifying coordinates of the bolt holes 21 at the four spots (bolt holes 21A, 21B, 21C and 21D shown in FIG. 9) in the image of the track shoe 2 being photographed by the infrared 3D camera 52. By means of attracting the center position, which is the gravity center of the track shoe 2 by the distal-end member 64E, the track shoe 2 attracted by the track-shoe pickup member 64 is picked up by the 3-axis orthogonal robot 50C without inclination.

The “determined order”, which is the order of picking up the track shoe, is determined on the basis not only the contents explained with reference to FIG. 8 but also the coordinates in the height direction, the coordinates (coordinates in the XY-axis direction) on the plane (XY-axis plane), and the bolt hole position of the track shoe 2.

In FIG. 10, the track shoe 2 picked up by the track-shoe pickup member 64 of the 3-axis orthogonal robot 50C moves to the right direction in FIG. 10 with respect to the X-axis direction and is transferred to the track-shoe transfer device 50D (FIG. 1 to FIG. 3: not shown in FIG. 10).

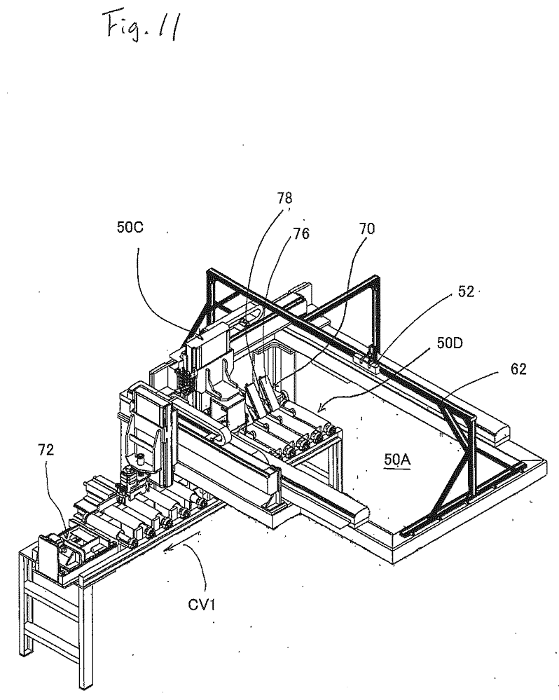

Relative positions relationships between the track-shoe supply unit 50A, the 3-axis orthogonal robot 50C, and the track-shoe transfer device 50D are shown in FIG. 11, which is a drawing extracting a part of the track-shoe transport system 50 (FIG. 1 to FIG. 3).

In the illustrated embodiment, as described above, the infrared 3D camera 52 and the 3-axis orthogonal robot 50C are applied, in order to move the track shoe 2 loaded on the pallet 55 (not shown in FIG. 1, FIG. 11) accommodated in the track-shoe supply unit 50A to the track-shoe transfer device 50D.

In FIG. 11, a distance (1, 250 mm) between the infrared 3D camera 52 fixed to the frame body 62 and the track shoe 2 (uppermost track shoe 2 loaded on the pallet 55: not shown in FIG. 11: refer to FIG. 10) to be picked up, is a distance suitable for photographing an image of the track shoe 2, and is a distance being set so that an interfere with a movable region of the track-shoe pickup member 64 (not shown in FIG. 11: see FIG. 10) in the 3-axis orthogonal robot 50C will not be happened. Here, the frame body 62 to which the infrared 3D camera 52 is fixed is an outer frame body of the 3-axis orthogonal robot 50C. By appropriately fixing the infrared 3D camera 52 to the frame body 62, which is the outer frame body of the 3-axis orthogonal robot 50C, an interference between the track shoe pickup member 64 and the infrared 3D camera 52 is prevented.

By photographing the image of the track shoe 2 to be picked up by the infrared 3D camera 52, images of the plurality of track shoes 2 placed on the uppermost stage of the pallet 55 can be processed entirely and in a lump sum.

By processing images of the plurality of track shoes 2 entirely, it is possible to reduce a cycle time for determining coordinates of each of the e predetermined positions (predetermined position in a state placed on the uppermost stage of the pallet 55) in each track shoe 2.

Here, a multi-axis robot (not shown) can be applied, in order to move the track shoe 2 loaded on the pallet 55 to the track-shoe transfer device 50D. However, the multi-axis robot is over specification for moving the track shoe 2 to the track-shoe transfer device 50D and is expensive, and then there is disadvantageous for the multi-axis robot in view of the cycle time aspect. And the multi-axis robot requires a relatively wide installation space, which is against a request for space saving. Therefore, in the illustrated embodiment, the 3-axis orthogonal robot 50C is selected, constructions of which is simple, installation of which is possible even in a small space (4 m×3.5 m, for example), introduction costs of which are low and moreover, and operations of which are stable.

Though not clearly indicated in the illustrated embodiment, in the installation space of the track-shoe transport system 50, in order to prevent lowering of the image recognition function of the infrared 3D camera 52 and to improve reproducibility of images, a sunlight shielding plate (not shown) is provided at a window and other opening parts in the vicinity of the installation space so that direct sunlight does not illuminate the track shoe 2. Such a sunlight shielding plate can be constructed by a curtain made of cloth, for example.

By installing the sunlight shielding plate, not shown, an influence of ambient light to the infrared 3D camera 52 can be excluded, and the infrared 3D camera 52 can sufficiently exert its performances, even though the infrared 3D camera 52 is relatively susceptible to ambient light. As a result, it is not necessary to apply a laser 3D scanner, which is resistant to the ambient light but expensive.

In FIGS. 1 to 3 and 11, the track shoe 2 is moved by the 3-axis orthogonal robot 50C from an area on the pallet 55 (FIG. 6, FIG. 10) onto the track-shoe transfer device 50D. Regarding to the track shoe 2 at a point of time when having moved to the track-shoe transfer device 50D, the direction in which the rugs R1 to R3 protrude (that is, whether the front side of the track shoe 2 faces upward or the rear side of the track shoe 2 faces upward) is in the same manner (state) as the track shoe is loaded on the pallet 55. As described above, in order to improve the pallet loading efficiency, the track shoes 2 are not loaded in the same manner (attitude) on the pallet 55. Therefore, whether the rugs R1 to R3 of the track shoe 2 face upward or face downward (whether the front side of the track shoe 2 faces upward or the rear side of the track shoe 2 faces upward) is not constant. Here, said track shoe has been moved by the 3-axis orthogonal robot 50C to the track-shoe transfer device 50D.

However, for processing after the track shoes have been moved to the track-shoe transfer device 50D, all the track shoes 2 need to be transported on the track-shoe transfer device 50D in a state that the rugs R1 to R3 face upward (in a manner that the front side of the track shoe 2 faces upward).

Therefore, e illustrated embodiment, in the track shoe 2 having been moved to the track-shoe transfer device 50D, the track shoe 2 the rugs R1 to R3 of which face downward (track shoe 2 with the front side facing downward) is reversed by the track-shoe reversing device 70 (FIG. 11) and is brought into a state that the rugs R1 to R3 face upward (in a manner that the front side faces upward).

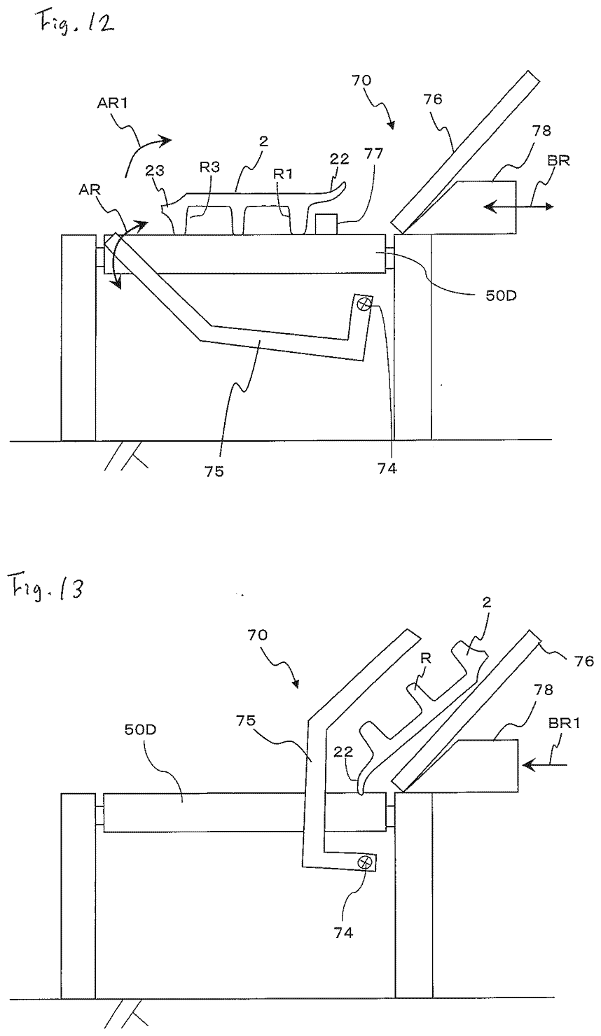

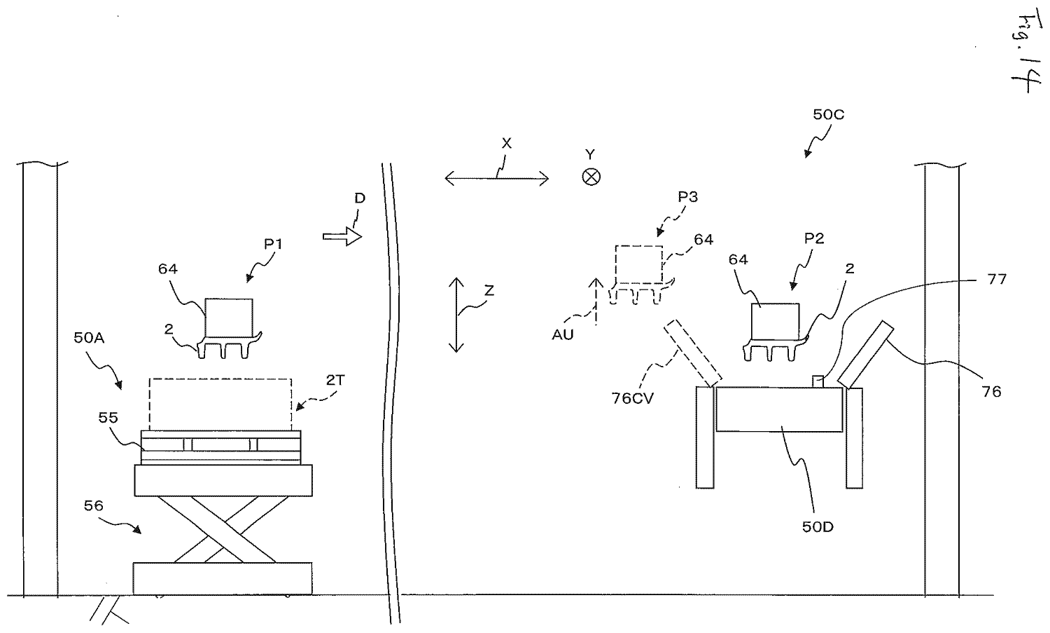

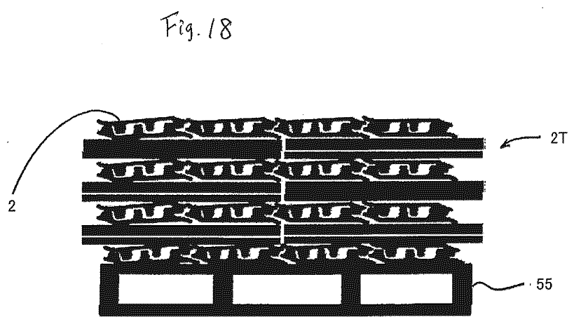

Note that the short side 22 of the track shoe 2 (FIG. 4, FIG. 5) is set so as to face a side of the pin hole (see FIG. 17) of the link in the link belt 10 being transported on the link-belt transport device 50F. In other words, the track shoe 2 is placed on the track-shoe transfer device 50D so that the short side 22 side is on the left side (the side being closer to the track-shoe supply unit 50A or the pallet 55) in FIG. 12 and FIG. 13.

FIG. 12, FIG. 13 illustrate a state that the track-shoe transfer device 50D is viewed from a side (a side opposite to the arrow CV1 in FIG. 11) being remote from the link-belt transport device 50F. In FIG. 1 to FIG. 3 and FIG. 11, the link-belt transport device 50F is not shown.

As described above, since the track shoe 2 is placed on the track-shoe transfer device 50D in the same manner as being loaded on the pallet 55, by photographing the track shoe 2 being placed on the pallet 55 by means of the infrared 3D camera 52 and recognizing an image thereof, whether the track shoe is placed on the track-shoe transfer device 50D in a state that the rugs R1 to R3 face upward (a state that the front side of the track shoe 2 faces upward) or the track shoe is placed on the track-shoe transfer device 50D in a state that the rugs R1 to R3 face downward (a state that the front side of the track shoe 2 faces downward) has been already determined at a point of time that the track shoe 2 is placed on the track-shoe transfer device 50D, when the track shoe 2 is picked up by the track-shoe pickup member 64 of the 3-axis orthogonal robot 50C.

In the illustrated embodiment, it is constructed such that the track shoe 2 of the track-shoe transfer device 50D is transported in the state that the rugs R1 to R3 face upward (a state that the front side faces upward). And the track shoe 2 placed on the track-shoe transfer device 50D in the state that the rugs R1 to R3 face downward (a state that the rear side faces upward) is reversed by the track-shoe reversing device 70 to the state that the rugs R1 to R3 face upward (a state that the front side faces upward).

The track-shoe reversing device is entirely indicated by a character 70 in FIG. 11 and FIG. 2, and will be explained with reference to FIG. 12 and FIG. 13.

As described above, in the illustrated embodiment, the track shoe 2 should be placed on the track-shoe transfer device 50D in the state that the rugs R1 to R3 thereof face upward (a state that the front side of the track shoe 2 faces upward) and transported. In a manner shown in FIGS. 12 and 13, the track shoe 2, which is placed on the track-shoe transfer device 50D such a manner that the rugs R (R1 to R3: FIG. 5, FIG. 7) face downward (a state that the front side of the track shoe 2 faces downward), is reversed and brought into the state that the rugs R1 to R3 face upward. Whether or not the rugs R1 to R3 of the track shoe 2 placed on the track-shoe transfer device 50D faces downward is determined from the image of the track shoe 2 photographed by the infrared 3D camera 52 in the form explained with reference to FIG. 7 and FIG. 9, for example.

In FIG. 12, the track-shoe reversing device 70 includes the reversing member 75 rotationally moving in an arrow-AR direction around the rotational-movement center 74, a track-shoe receiving base 76 which receives the reversed track shoe 2, a fulcrum member 77 which becomes a fulcrum when the track shoe 2 is reversed by the reversing member 75, and a pressing member 78. The pressing member 78 reciprocates in an arrow-BR direction in order to place the reversed track shoe 2 in the state that the rugs R1 to R3 face upward on the track-shoe transfer device 50D.

The reversing member 75 is rotationally moved by drive means, not shown, between a position below the track-shoe transfer device 50D illustrated in FIG. 12 and a position close to the track-shoe receiving base 76 shown in FIG. 13. When the reversing member 75 is rotationally moved in an arrow-AR1 direction from the state in FIG. 12, the long side 23 side of the track shoe 2 is pressed by the reversing member 75 from below to above and is brought into a state that the track shoe 2 is leaning against the track-shoe receiving base 76.

When the track shoe 2 is rotationally moved in the arrow-AR1 direction together with the reversing member 75 from the state shown in FIG. 12, the rug R1 on the short side 22 side of the track shoe 2 contacts with the fulcrum member 77. The track shoe 2 is rotationally moved in the arrow-AR1 direction together with the reversing member 75 such a manner that the contact spot with the fulcrum member 77 operates as a fulcrum (or a rotational movement center) and is brought into the state that the track shoe 2 is leaning against the track-shoe receiving base 76 as shown in FIG. 13.

From the state shown in FIG. 13, in order to place the track shoe 2 on the track-shoe transfer device 50D in the state that the rugs R1 to R3 face upward, the pressing member 78 moves to the side of an arrow BR1 side from the state shown in FIG. 13 and presses a region on the short side 22 side (side of the track-shoe transfer device 50D in FIGS. 12 and 13) of the track shoe 2.

As shown in FIG. 11, the track-shoe receiving base 76 and the pressing member 78 are provided in plural by being disposed alternately in the transport direction CV1 (see FIG. 11: a direction being perpendicular to the paper surface of FIGS. 12 and 13) of the track-shoe transfer device 50D. Therefore, even if the pressing member 78 moves to the arrow BR1 side from the state shown in FIG. 13, the pressing member 78 can press the region of the short side 22 side (side of the track-shoe transfer device 50D shown in FIGS. 12 and 13) of the track shoe 2, without interfering with the track-shoe receiving base 76.

When the pressing member 78 moves in the arrow-BR1 direction from the state shown in FIG. 13 and presses the area of the short side 22 side (a side of the track-shoe transfer device 50D shown in FIGS. 12 and 13) of the track shoe 2, the track shoe 2 in the state shown in FIG. 13 slides and is placed on the track-shoe transfer device 50D in the state that the rugs R (R1 to R3) face upward. And the track shoe 2 in the state that the rugs R (R1 to R3) faces upward is transported on the track-shoe transfer device 50D in the transport direction CV1 (see FIG. 11: direction perpendicular to the paper surface of FIGS. 12 and 13).

The track shoe 2 reversed by the track-shoe reversing device 70 and placed on the track-shoe transfer device 50D has the rugs R1 to R3 facing upward (a state that the front side of the track shoe 2 faces upward), and the short side 22 side of the track shoe 2 is on the side of the track-shoe supply unit 50A (left side in FIG. 12 and FIG. 13).

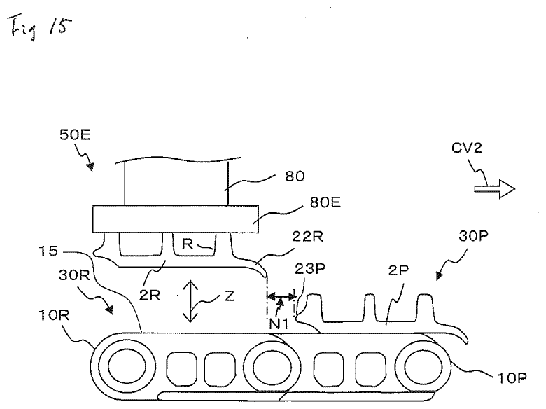

The track-shoe receiving base 76 is provided on the right side (a side being remote from the track-shoe supply unit 50A in the track-shoe transfer device 50D or the pallet 55) in FIGS. 12 and 13. The reason therefor will be explained with reference to FIG. 14. For simplification of illustration of FIG. 14, the 3-axis orthogonal robot 50C is shown only the track-shoe pickup member 64.

In FIG. 14, in the track-shoe supply unit 50A, by means of the track-shoe pickup member 64, the track shoe 2 on the uppermost stage in the large number of track shoes 2 entirely indicated by the character 2T placed on the pallet 55 is attracted, and then, the attracted track shoe 2 is lifted to the position P1 not interfering with the other large number of track shoes 2T. In this state, by moving the track-shoe pickup member 64 to the right side (a side remote from the track-shoe supply unit 50A or the pallet 55) in FIG. 14 (arrow D), the track shoe 2 (or the distal-end member 64E carrying the attracted track shoe 2) can be moved to the position (P2) immediately above the track-shoe transfer device 50D.

In FIG. 14, if the track-shoe receiving base 76 is provided on the right side in FIGS. 12 and 13 (a side remote from the track-shoe supply unit 50A or the pallet 55 in the track-shoe transfer device 50D), when the track-shoe pickup member 64 is moved from the track-shoe supply unit 50A to the position immediately above the track-shoe transfer device 50D, only movement in the X-axis direction (left-right direction in FIG. 14) is performed, while the movement in the Z-axis direction (up-down direction in FIG. 14) is not performed.

In FIG. 14, if the track-shoe receiving base 76 is provided at a virtual position 76CV being indicated by a dotted line, that is, by assuming that the track-shoe receiving base 76 is provided on the left side in FIGS. 12 and 13 (a side being close to the track-shoe supply unit 50A or the pallet 55 in the track-shoe transfer device 50D), when the track-shoe pickup member 64 at the position P1 is moved to the right side in the X-axis direction, the distal-end member 64E carrying the attracted track shoe 2 interferes with the track-shoe receiving base 76CV at the virtual position.

In order to prevent interference with the track-shoe receiving base 76CV at the virtual position, the track-shoe pickup member 64 should rise (should move in an arrow-AU direction) to a position (P3) of the virtual distal-end member 64E indicated by a dotted line in FIG. 14, should move across the area above the track-shoe receiving base 76CV at the virtual position, should lower again, and should move to a position (P2) immediately above the track-shoe transfer device 50D. That is, in a case that the track-shoe receiving base 76CV at the virtual position indicated by the dotted line is disposed, as compared with a case that the track-shoe receiving base 76 is provided on the right side as shown in FIGS. 12 and 13 (a case that the track-shoe receiving base 76 is provided on the side separated from the track-shoe supply unit 50A or the pallet 55 in the track-shoe transfer device 50D), it is necessary for the track-shoe pickup member 64 and the distal-end member 64E to move upward in the Z-axis direction to the position P3 and to move downward in the Z-axis direction to the position P2, whereby number of the movements in the Z-axis direction is increased.

Therefore, in the illustrated embodiment, in order to decrease a number of the movements in the Z-axis direction of the track-shoe pickup member 64 and the distal-end member 64E, the track-shoe receiving base 76 is provided on the right side (a side being remote from the track-shoe supply unit 50A or the pallet 55 in the track-shoe transfer device 50D) which side is shown in FIG. 12, FIG. 13, and the movements of the track-shoe pickup member 64 and the distal-end member 64E upward in the Z-axis direction to the position P3 and downward in the Z-axis direction to the position P2 are made unnecessary.

The track shoe 2 placed on the track-shoe transfer device 50D in the state that the rugs R1 to R3 face upward (a state that the front side of the track shoe 2 faces upward) is transported by the track-shoe transfer device 50D (transported in the arrow-CV1 direction in FIG. 1 to FIG. 3) and transported to the position above the link-belt transport device 50F in FIG. 1 to FIG. 3. The track shoe 2 having been transported to the position above the link-belt transport device 50F is stopped by a transfer stop device 72 at a predetermined position in the track-shoe transfer device 50D.

The transfer stop device 72 is constructed as a stopper and is constructed so as to be capable of adjusting a stop position of the track shoe 2. The stop position of the track shoe 2 in the track-shoe transfer device 50D is determined depending upon each type of the track shoe 2 and a length of the track shoe 2.

The track shoe 2 stopped by the transfer stop device 72 at the predetermined position of the track-shoe transfer device 50D is placed on the link belt 10 on the link-belt transport device 50F, which is a transport device for feeding the link belt 10 to the bolt-nut fastening device by the 2-axis orthogonal robot 50E in the state that the rugs R1 to R3 face upward (a state that the front side of the track shoe 2 faces upward).

The 2-axis orthogonal robot 50E is movable in the link-belt feeding direction (CV2) and the Z-axis direction in FIG. 1 and FIG. 2 and places the track shoe 2 transported by the track-shoe transfer device 50D at the predetermined position of the link belt 10 (corresponding link belt 10) being transported on the link-belt transport device 50F.

Here, in order to place the track shoe 2 on the track-shoe transfer device 50D at the predetermined position of the link belt 10 (corresponding link belt 10) on the link-belt transport device 50F, a multi-axis robot (not shown) can be applied. However, the multi-axis robot is over specification for moving the track shoe 2 on the track-shoe transfer device 50D to the predetermined position of the link belt 10 on the link-belt transport device 50F, is expensive, and is disadvantageous in view of the cycle time aspect. Also, since it is necessary for the multi-axis robot to be provided in a relatively wide installation space, it is against a request for space saving. Thus, in the illustrated embodiment, the 2-axis orthogonal robot 50E is adopted, constructions of which are simple, an installation of which is possible even in a small space (4 m×3.5 m, for example), introduction costs of which are low, and moreover, operations of which are stable.

Moreover, since the 2-axis orthogonal robot 50E does not move in the transport direction of the track-shoe transfer device 50D, the track shoe 2 stopped by the transfer stop device 72 at the predetermined position can be moved to above the corresponding link belt 10 without moving from the predetermined position in the transport direction of the track-shoe transfer device 50D. Therefore, by means of the 2-axis orthogonal robot 50E, there is such an advantage that a movement to above the link belt 10 is possible without changing the predetermined position in the transport direction of the track-shoe transfer device 50D. Here, the position of the track shoe 2 in the transport direction of the track-shoe transfer device 50D is fixed to a proper position all the time by properly adjusting the stop position by the transfer stop device 72.

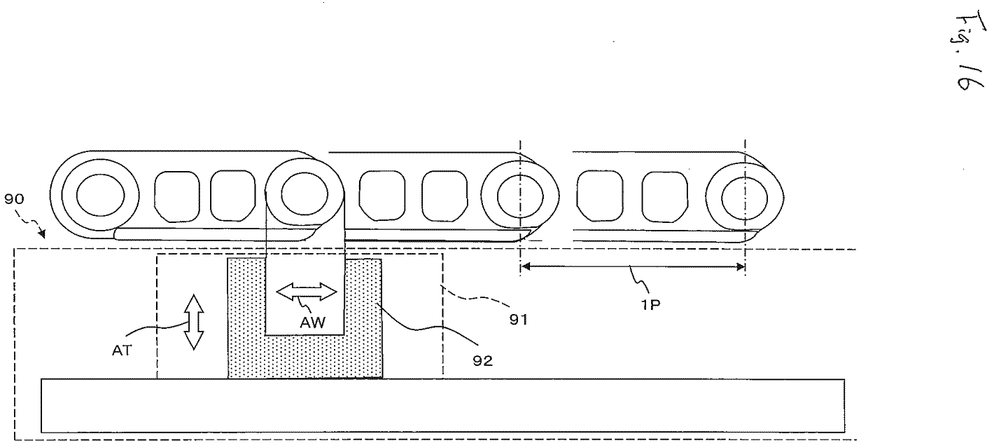

A manner that the track shoe 2 is placed on the link belt 10 on the link-belt transport device 50F by the 2-axis orthogonal robot 50E will be explained with reference to FIG. 15. For simplification of illustration, in FIG. 15, only (a piece of) a preceding link belt 10P, a track shoe 2P placed on the preceding link belt 10P, and a track shoe 2R which should be placed on (a piece of) a subsequent link belt 10R are shown.

The track shoe 2 placed on the link-belt transport device 50F from on the track-shoe transfer device 50D (not shown in FIG. 15) is in a state that the rugs R (R1 to R3) face upward (a state that the front side of the track shoe 2 faces upward) and that the short side 22 side of the track shoe 2 faces the link-belt feeding direction (arrow-CV2 direction).

As shown in FIG. 15, the track shoe 2R for the subsequent piece is suspended by the 2-axis orthogonal robot 50E. In FIG. 15, regarding the 2-axis orthogonal robot 50E, only a track-shoe attracting portion 80 and a distal end portion 80E thereof are shown. Here, the distal end portion 80E attracts and suspends the track shoe 2 made of steel by a magnetic force, for example.

When the track shoe 2R is to be placed on the subsequent link belt 10R, the subsequent track shoe 2R attracted by the distal end portion 80E moves in the arrow-CV2 direction to the position above the corresponding link belt 10 (subsequent link belt 10R) and is held in a stationary state (see FIG. 15). Here, in the state shown in FIG. 15, regarding a long side 23P of the track shoe 2P of the preceding piece 30P and a short side 22R in the subsequent track shoe 2R attracted by the distal end portion 80E, their planar positions (left-right direction positions in FIG. 15) are separated only by an interval N1 and do not overlap when visually recognized from the information in the Z-axis direction.

Subsequently, in FIG. 15, at the position above the subsequent link belt 10R, the subsequent track shoe 2R held by the distal end 80E of the 2-axis orthogonal robot 50E is lowered downward in the Z-axis direction (see FIG. 15) to the corresponding subsequent link belt 10R.

In a state that the subsequent track shoe 2R is lowered to (placed on) the subsequent link belt 10R, the short side 22R of the lowered subsequent track shoe 2R enters below the long side 23P of the track shoe 2P in the preceding link belt 10P and moves only by N1+α in the link-belt feeding direction CV2 by the 2-axis orthogonal robot 50E so that planar positions thereof overlap each other. Here, the distance N1 is, as shown in FIG. 15, a horizontal-direction distance between a distal end of the long side 23P of the preceding track shoe 2P and a distal end of the short side 22R of the subsequent track shoe 2R. Though not shown in FIG. 15, the distance & is an overlap margin between the long side 23P of the preceding track shoe 2P and the short side 22R of the subsequent track shoe 2R. A value of α is different depending on a type of a track and the track shoe, but it is determined as an overlap margin required to prevent intrusion of mud when a construction machine travels on mud.

As shown in FIG. 5, in the state that the rugs R1 to R3 face upward, an end part on the short side 22 side of the track shoe 2 is curved downward, while an end part on the long side 23 side is curved upward. Therefore, in the state shown in FIG. 15, by moving the subsequent track shoe 2R having been lowered to the link belt 10R of the subsequent link only by N1+α in the link-belt feeding direction CV2, the short side 22R of the subsequent track shoe 2R enters below the long side 23P of the preceding track shoe 2P, whereby positions on the plane overlap each other. As a result, the continuous track shoes 2P, 2R can be introduced into the bolt-nut fastening device in a state that the short side 22R of the subsequent track shoe 2R overlaps the long side 23P of the preceding track shoe 2P. This contributes to reduction of a work labor in an assembling process being not shown.

Though not clearly shown in FIG. 15, the link belt 10 on the link-belt transport device 50F can be transferred by one pitch at a time in the link-belt feeding direction (arrow-CV2 direction in FIG. 15) by means of a pitch feeding device 90 (see FIG. 1 to FIG. 3).

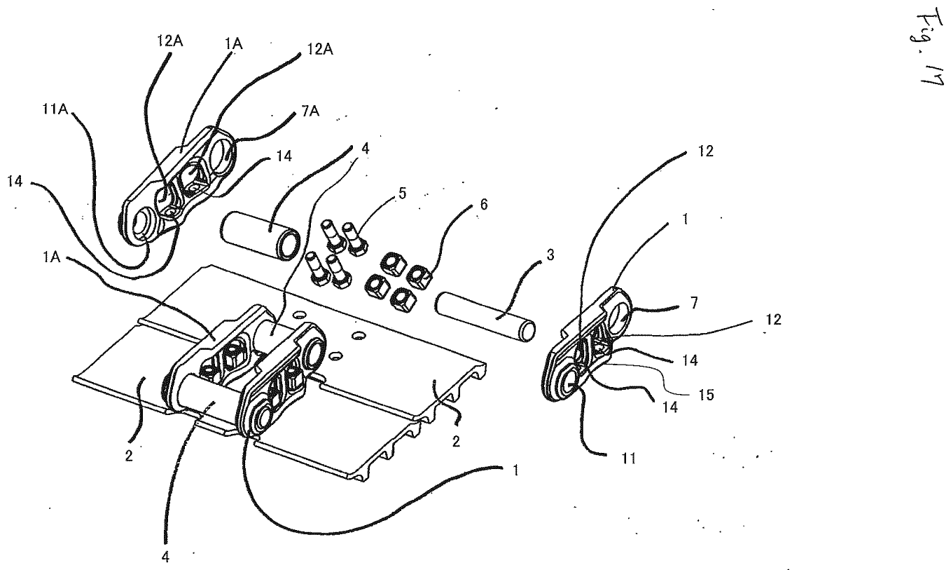

In the prior arts, a pitch feeding device was provided in the link-belt transport device too, but in the prior pitch feeding device, an inner width of a jig sandwiching a bush is fixed, and a procedure of exchanging the jig sandwiching the bush was necessary each time the type of the link belt 10 was changed. On the other hand, as shown in FIG. 16, the pitch feeding device 90 (FIG. 1 to FIG. 3) being provided in the illustrated embodiment includes a grasping portion 91 and a grasping-portion adjusting device 92 and the grasping portion 91 has such a variable structure that an inner width and a height thereof can be adjusted.

In FIG. 16, the grasping portion 91 constructs a mechanism for holding the link belt 10 and feeding by 1 pitch. In FIG. 16, 1 pitch is indicated by a character 1P.

The grasping-portion adjusting device 92 is capable of adjusting a width (inner width) between the grasping portions 91 in an arrow-AW direction and is also capable of adjusting a height (up-down direction position in FIG. 16: arrow-AT direction position) of the grasping portion 91. Thus, even if the type of the link belt 10 is changed, by adjusting the inner width and the height of the grasping portion 91, it is not necessary an exchanging procedure for the grasping portion 91. Thus, as compared with the prior art requiring a procedure of exchanging the grasping portion each time the type of the link belt 10 is changed, the labor at the type change of the link belt 10 is extremely decreased.

In the illustrated embodiment, a method is proposed in which method the plurality of track shoes 2 on the uppermost stage loaded on the pallet 55 (FIG. 6, FIG. 10) is collectively photographed, and the number of picking candidates on the plane constructed by the plurality of track shoes 2 positioned on the uppermost stage is determined and a picking-up order based on the track-shoe photographing data (image data of the uppermost stage) is proposed. However, it is also possible to perform so as to determine the picking target each time by picking up the track shoe 2 one by one.

Moreover, in the illustrated embodiment, the front side and the rear side of the track shoe 2 and the bolt hole 21 are detected from the track-shoe image data, and the attitude of the track shoe 2 is recognized by the bolt hole position or presence/absence of the groove in the short side, however, it is also possible to perform a manner that all the information are detected by photographed dates and the attitude of the track shoe 2 is recognized.

According to the illustrated embodiment, the cycle time can be shortened as compared with the prior arts, and parallel processing synchronized with the cycle time of the bolt-nut fastening device, which is a subsequent process, was made possible. As a result, such a goal of automatic that a track shoe 2 can be input into the bolt-nut fastening device in a cycle time of 8.5 seconds can be achieved.

Moreover, the heavy labor that the track shoe 2, which is a heavy item (60 to 70 kg/sheet), is repeatedly input into the line in the cycle time of 8.5 seconds in the shortest can be excluded. As a result, the number of operators can be reduced, whereby an effect of reduction in a labor cost can be expected.

The system according to the illustrated embodiment can be installed in a narrow space of 4 m×3.5 m, for example, and the problem related to the installation space in the track-shoe transport system 50 can be solved.

Further, according to the illustrated embodiment, as the result of devising of the methods of the camera and the robot, such facilities that can ensure high productivity of an 8.5-second cycle at the shortest can be realized with an extremely low cost.

The system 50 of the illustrated embodiment can be extended to an automation of a track-shoe supply device whether manufacturing facilities are in or outside the country.

And at a manufacturing site where various types of track shoes are mixed, when the type of the track shoe is changed, the system can be applied to automatic loading without taking any procedure accompanying the type change.

It is to be noted that the illustrated embodiment is only exemplification and it is not a description in which there is not an intention to limit the technical scope of the present invention.

### Reference Characters List

2 Track shoe
10 Link belt
21A, 21B, 21C, 21D Bolt hole of track shoe
50 Track-shoe transport system
50A Track-shoe supply unit
50B Track-shoe detection mechanism
50C Track-shoe pickup mechanism (3-axis orthogonal robot)
50D Track-shoe transfer device
50E Track-shoe disposition mechanism (2-axis orthogonal robot)
50F Link-belt transport device
52 Infrared 3D camera
54 Photoelectric sensor
55 Pallet
56 Lift device
70 Track-shoe reversing device
74 Rotational-movement center
75 Reversing member
76 Track-shoe receiving base
77 Fulcrum member
78 Pressing member
100 Control device
R1, R2, R3 Rug of track shoe

1. A track-shoe transport system, comprising:
a track-shoe supply unit that accommodates a pallet on which a track shoe is loaded and is provided a lift device lifting the pallet;
a track-shoe detection mechanism which detects the track shoe being supplied from the track-shoe supply unit;
a control device which determines a state of the detected track shoe on the basis of a detection being result of the track-shoe detection mechanism;
a track-shoe pickup mechanism which picks up the track shoe detected by the track-shoe detection mechanism;
a track-shoe transfer device which transports the track shoe picked up by the track-shoe pickup mechanism;
a track-shoe disposition mechanism which disposes the track shoe transported by the track-shoe transfer device in alignment with each partition of a link belt; and
a link-belt transport device which transports the link belt and the track shoe on the link belt.

2. The track-shoe transport system according to claim 1, wherein
the track-shoe detection mechanism is fixed and has a function for photographing a plurality of track shoes on an uppermost stage loaded on the pallet and for dispatching information relating to the plurality of track shoes to a control device; and
the control device has a function for determining a type of the track shoe, a position of a bolt hole, a direction in which a rug protrudes, a depth of the rug, and a front side and a rear side of the track shoe, on the basis of information from the track-shoe detection mechanism, and a function for determining an order of picking up the track shoe.

3. The track-shoe transport system according to claim 1, wherein
the track-shoe supply unit has a photoelectric sensor, the photoelectric sensor is fixed, and has a function for measuring a perpendicular-direction distance between the uppermost track shoe and the track-shoe detection mechanism in the track shoe loaded on the pallet and for dispatching the same to the control device; and
the control device has a function for lifting the lift device in a cast that the perpendicular-direction distance between the uppermost track shoe loaded on the pallet and the track-shoe detection mechanism is less than a predetermined distance, and a function for stopping the lifting of the lift device in a case that the perpendicular-direction distance between the uppermost track shoe loaded on the pallet and the track-shoe detection mechanism is equal to or larger than the predetermined distance.

4. The track-shoe transport system according to claim 1, wherein
a track-shoe reversing device is provided on a side being away from the track-shoe supply unit in a first transport line; and
the track-shoe reversing device includes:
a reversing member which rotationally moves around a rotational-movement center;
a track-shoe receiving base which receives the reversed track shoe;
a fulcrum member to be a support of reversing when the track shoe is reversed by the reversing member; and
a pressing member which presses the track shoe in a state that a rug being reversed and facing upward is caused to slide on the track-shoe transfer device.
